(19) United States
(12) Patent Application Publication
(10) Pub. No.: US 2005/0115638 A1
(43) Pub. Date: Jun. 2, 2005

(54) Shear attachment assembly

(76) Inventor: Larry R. Solesbee, Whitesburg, GA (US)

Correspondence Address: THOMAS, KAYDEN, HORSTEMEYER & RISLEY, LLP, 100 GALLERIA PARKWAY, NW, STE 1750, ATLANTA, GA, 30339-5948, US

(21) Appl. No.: 10/988,653

(22) Filed: Nov. 15, 2004

Related U.S. Application Data
(60) Provisional application No. 60/523,426, filed on Nov. 18, 2003.

(51) Int. Cl. A01G 23/08

(52) U.S. Cl. 144/4.1

(57) ABSTRACT

A shear attachment assembly comprises a blade assembly and a tine assembly. The tine assembly is arranged and configured to releasably receive a rake assembly thereon.

### CROSS-REFERENCE TO RELATED APPLICATION

This application claims priority to copending U.S. provisional application entitled, “Shear Attachment Assembly,” having Ser. No. 60/523,426, filed Nov. 18, 2003, which is entirely incorporated herein by reference.

### TECHNICAL FIELD

The present invention is generally related to construction equipment attachments and is particularly related to a shear attachment assembly.

### BACKGROUND OF THE INVENTION

Equipment and attachment members of various configurations are used in combination with various earth moving machinery and heavy duty equipment to accomplish a variety of tasks in construction, forestry, and excavating. These equipment and attachment members are typically attached to motorized equipment such as loaders, and excavators, to name a few.

One particular type of attachment works to excavate and chop wood members, which are typically large in size. Such attachments are commonly referred to as excavator wood/stump shears. As the name implies, this attachment is used to split stumps, logs, ties, poles, roots, etc. One type of excavator wood/stump shear primarily includes a blade portion opposing and pivotally fixed to a tine portion. The blade portion is one extending member with a blade on it that aligns with blocks in the tine portion. The blocks of the tine portion are surrounded by one tine on either side. The pair of tines and blocks therebetween can be used to hold or support a wood member, such as a stump, log, pole, etc. The blade portion moves about this pivotal connection to the tine portion to shear or chop the wood member.

This classic configuration of an excavator wood/stump shear however, does not have the capacity to push or scoop material, such as brush, that may be surrounding or covering the target wood member. In order to access and chop a covered stump, for example, using the classically configured excavator wood/stump shear, another piece of machinery, such as a skid steer grapple/rake, loader rake, thumb, or the like, would first need to be used to dig through, scoop and/or push the surrounding brush first.

The need for two pieces of machinery for this one job is undesirable due at least to the resultant increased costs to complete such a project incurred through increased equipment purchase and/or rental, possible multiple operators needed to operate the multiple equipment. The use of multiple equipment is also undesirable due to the resultant increased time lapsed to complete the project to switch, possibly more than once, positioning equipment to work in the desired area.

Thus, a heretofore unaddressed need exists in the industry to address the aforementioned deficiencies and inadequacies.

### SUMMARY OF THE INVENTION

Preferred embodiments of the present invention provide a shear attachment assembly. Briefly described, in architecture, one embodiment of the assembly can be implemented as follows. A shear attachment assembly comprises a blade assembly and a tine assembly where the tine assembly is arranged and configured to releasably receive a rake assembly.

Other systems, methods, features, and advantages of the present invention will be or become apparent to one with skill in the art upon examination of the following drawings and detailed descriptions. It is intended that all such additional systems, methods, features, and advantages be included within this description, be within the scope of the present invention, and be protected by the accompanying claims.

### BRIEF DESCRIPTION OF THE DRAWINGS

Many aspects of the invention can be better understood with reference to the following drawings. The components in the drawings are not necessarily to scale, emphasis instead being placed upon clearly illustrating the principles of the present invention. Moreover, in the drawings, like reference numerals designate corresponding parts throughout the several views.

FIG. 1 is a top perspective view of a preferred embodiment of the shear attachment assembly of the present invention mounted on a vehicle.

FIG. 1A is a top view of the shear attachment assembly mounted on the vehicle illustrated in FIG. 1.

FIG. 1B is a side view of the shear attachment assembly mounted on the vehicle illustrated in FIG. 1.

FIG. 1C is a front view of the shear attachment assembly mounted on the vehicle illustrated in FIG. 1.

FIG. 2 is a top perspective of another preferred embodiment of the shear attachment assembly of the present invention mounted on a vehicle.

FIG. 2A is a top view of the shear attachment assembly mounted on the vehicle illustrated in FIG. 2.

FIG. 2B is a side view of the shear attachment assembly mounted on the vehicle illustrated in FIG. 2.

FIG. 2C is a front view of the shear attachment assembly mounted on the vehicle illustrated in FIG. 2.

FIG. 3 is a perspective view of a tine assembly of the shear attachment assembly illustrated in FIG. 2.

FIG. 3A is a top view of the tine assembly of the shear attachment assembly illustrated in FIG. 2.

FIG. 3B is a side view of the tine assembly of the shear attachment assembly illustrated in FIG. 2.

FIG. 3C is a front view of the tine assembly of the shear attachment assembly illustrated in FIG. 2.

FIG. 4 is a perspective exploded view of the tine assembly of the shear attachment assembly illustrated in FIG. 1.

FIG. 4A is a top view of the tine assembly of the shear attachment assembly illustrated in FIG. 1.

FIG. 4B is a side view of the tine assembly of the shear attachment assembly illustrated in FIG. 1.

FIG. 4C is a front view of the tine assembly of the shear attachment assembly illustrated in FIG. 1.

FIG. 5 is a perspective view of a preferred embodiment of an optional rake assembly of the shear attachment assembly illustrated in FIG. 1.

FIG. 6 is a perspective view of a blade assembly of the shear attachment assembly illustrated in FIG. 1.

FIG. 7 is a side view of the shear attachment assembly illustrated in FIG. 1 disposed in an open position.

FIG. 8 is a side of the shear attachment assembly illustrated in FIG. 1 disposed in a closed position.

### DETAILED DESCRIPTION OF THE PREFERRED EMBODIMENTS

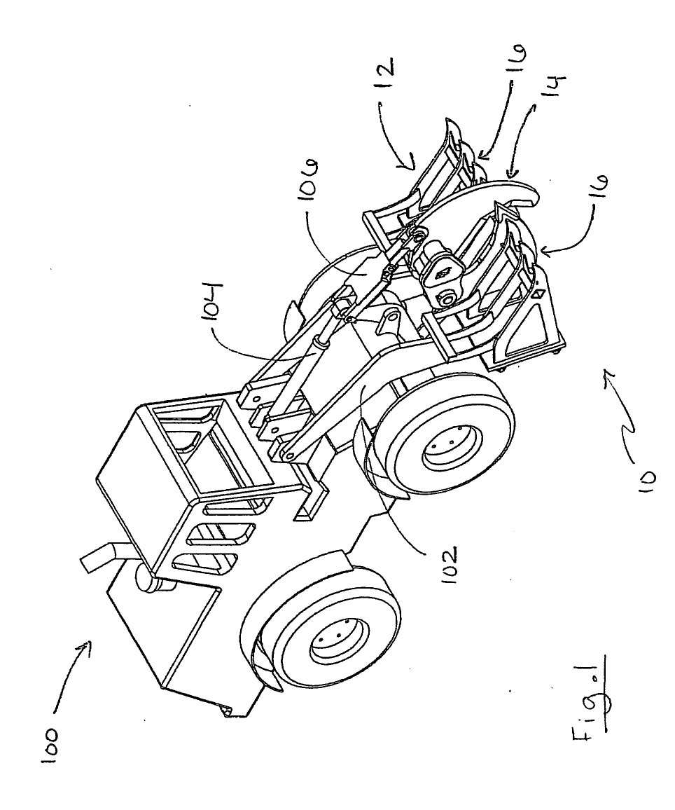

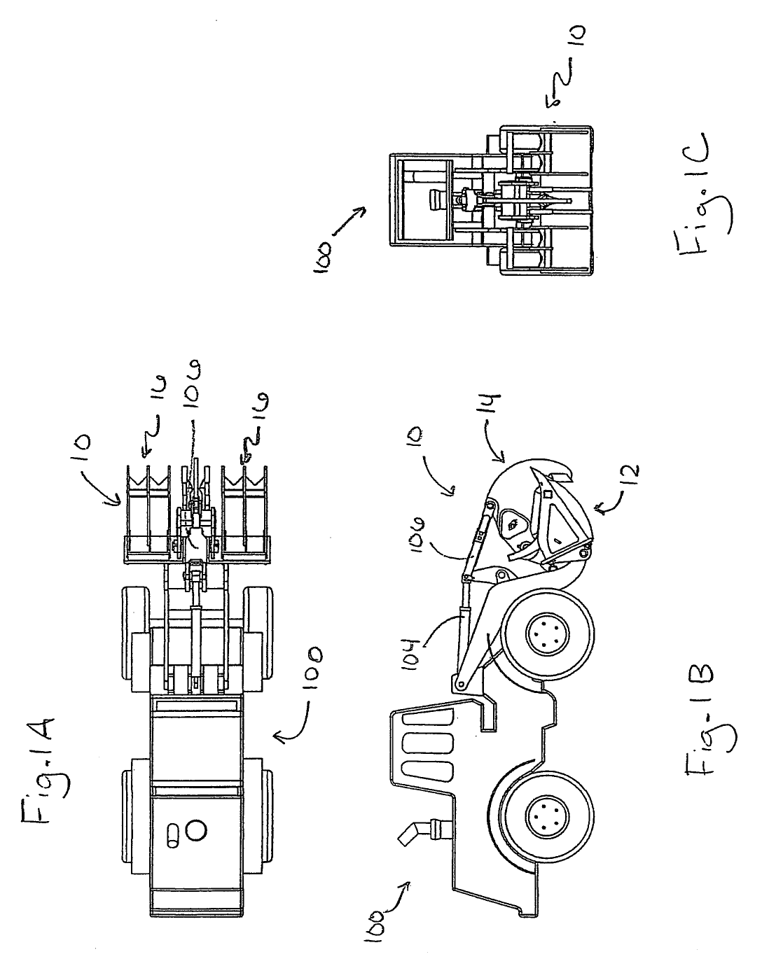

FIGS. 1-1C illustrate one embodiment of a shear attachment assembly 10 of the present invention. In the illustrated embodiment, the shear attachment assembly 10 is removably attached to a wheel loader 100. In other embodiments, the shear attachment assembly 10 may be fixed to another type of vehicle, such as a track loader (not shown), or the like. The shear attachment assembly 10 comprises a tine assembly 12 and a blade assembly 14. A loader arm 102 of the loader 100 receives the time assembly 12 and a hydraulic cylinder 104 releasably receives the blade assembly 14. In one preferred embodiment, the hydraulic cylinder 104 is attached to the blade assembly 14 via a shear attachment stabilizer arm 106. The shear attachment assembly 10 illustrated in FIGS. 1-1C further comprises a pair of optional rake assemblies 16. The rake assemblies 16 are disposed on the tine assembly 12 portion of the attachment 10.

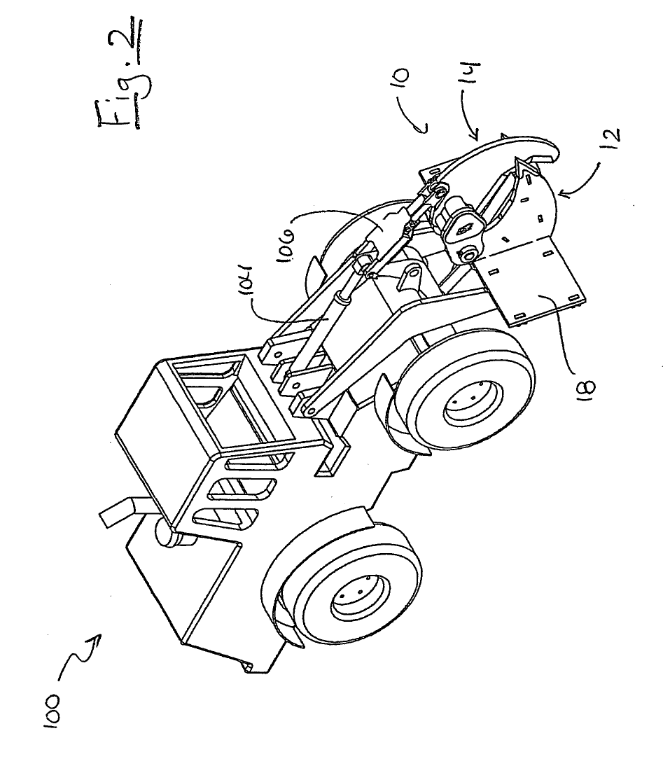

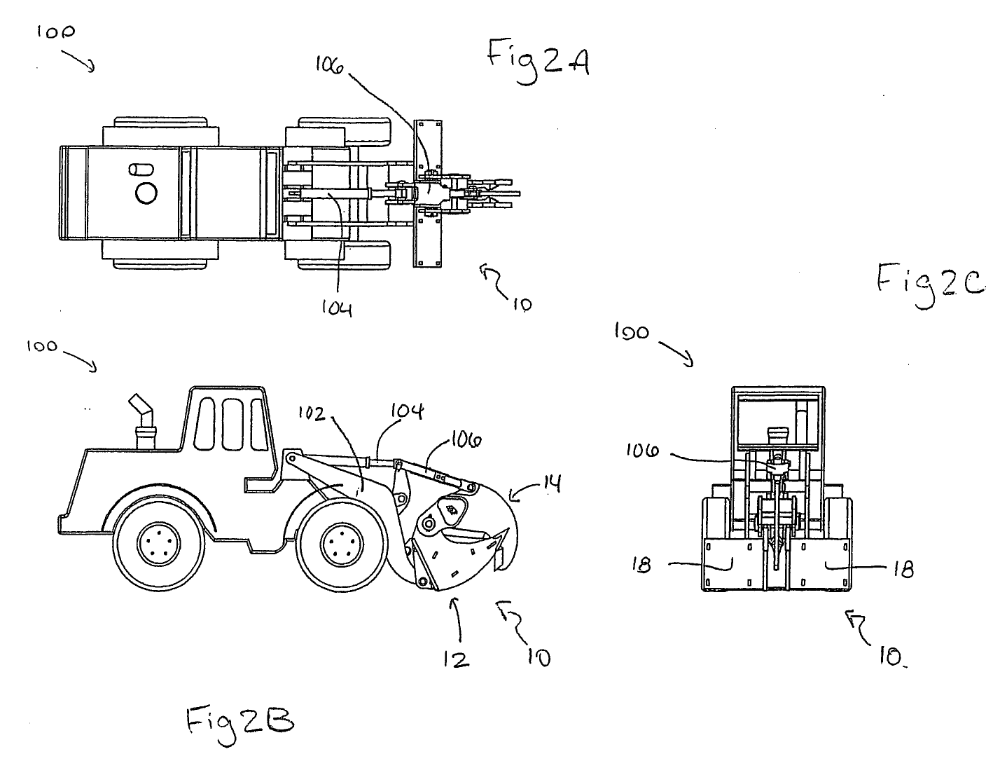

FIGS. 2-2C illustrate the shear attachment assembly 10 as mounted to a wheel loader 100 without the optional rake assemblies 16 fixed to the tine assembly 12. The optional rake assemblies 16 are discussed in greater detail hereinbelow.

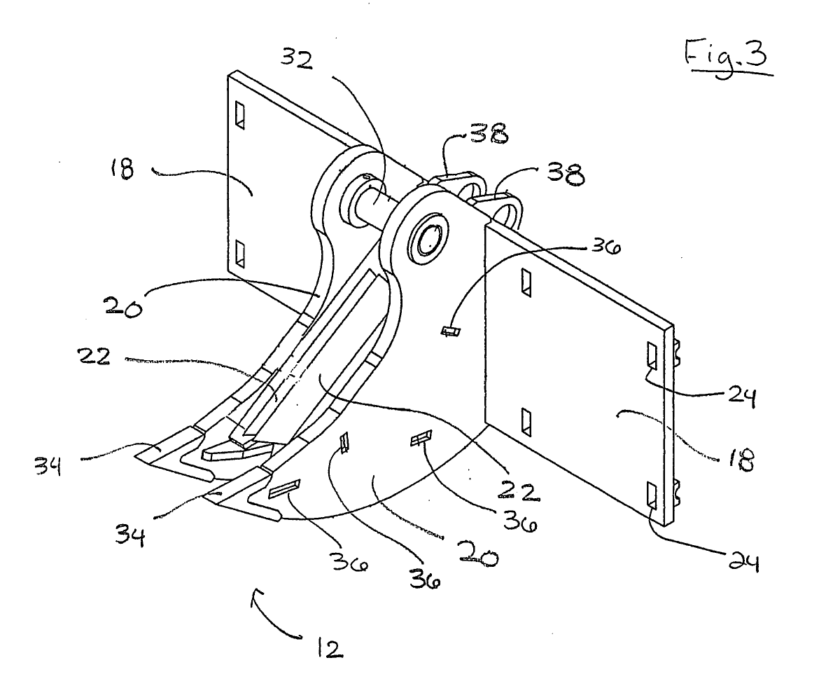

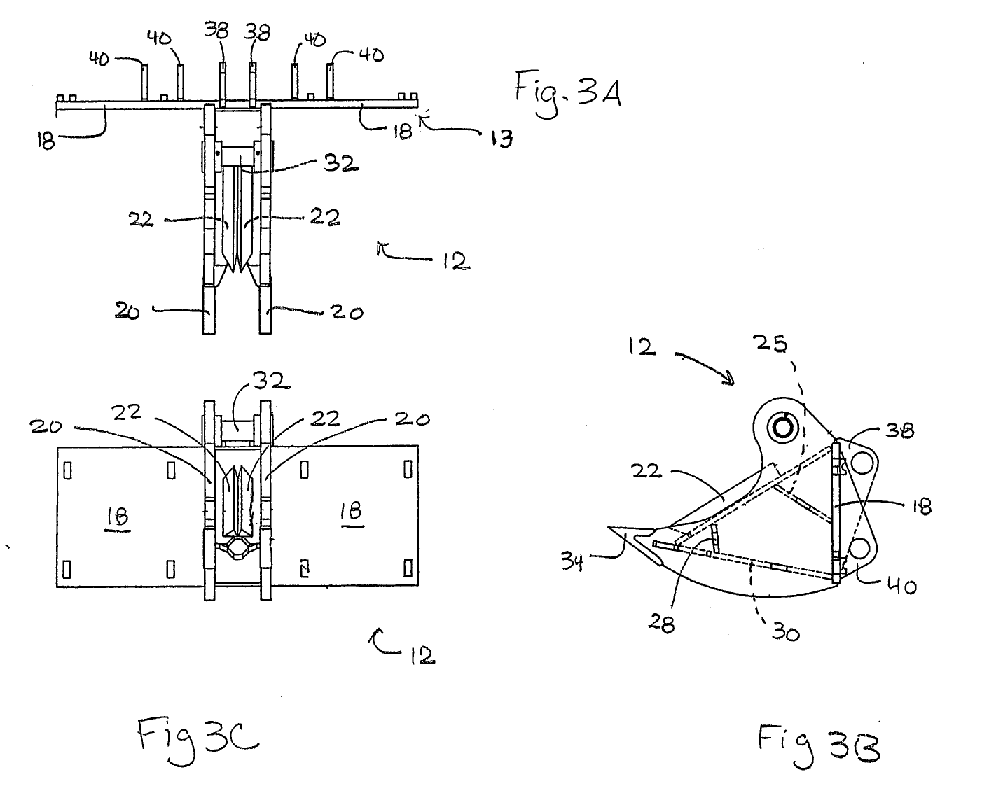

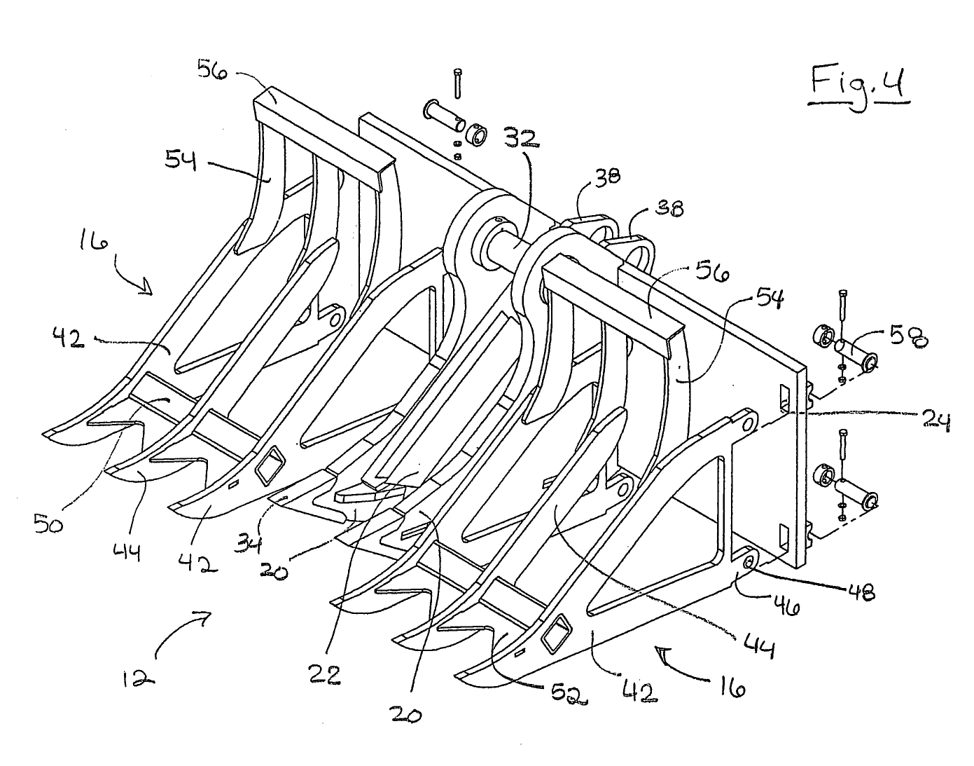

FIGS. 3-3C illustrate the tine assembly 12 of the shear attachment assembly 10 in greater detail. The configuration illustrated in FIGS. 3-3C shows the tine assembly 12 without the optional rake assembly 16 fixed thereto. More specifically, the tine assembly 12 comprises a frame 13, such as a pair of back plates 18, or the like, one back plate 18 disposed on each side of a pair of tine plates 20. It should be noted that the frame 13 can be any appropriate configuration, where the back plates 18 are but one example. Tine chop blocks 22 are disposed between the tine plates 20. Each back plate 18 includes a plurality of rake mounts 24 with which the optional rake assemblies 16 can be mounted to the tine assembly 12. In this configuration, the rake mount 24 is in the form of an aperture; however, it should be understood that any suitable mount may be implemented. From the pair of back plates 18 extends a pair of tine plates 20 being configured parallel to each other and having a pair of tine chop blocks 22 disposed therebetween and extending from the back plates 18 in the same direction as the tine plates 20.

Tine chop blocks 22 and tine plates 20 are supported internally by a series of plates (see FIG. 3C). A rear cross plate 25, crop plate 26, front cross plate 28, and bottom cross plate 30 (collectively referred to as “interior plates”) work together to support the tine plates 20 and tine chop blocks 22. A pivot cross tube 32 (see FIG. 3) is disposed between the tine plates 20, spanning across the tine chop blocks 22, and is arranged and configured to pivotally receive a portion of the blade assembly 14. Each tine plate 20 extends to a sharp pointed configuration, the tine tip 34, for more effective use. The interior plates are fixed between the pair of tine plates 20 with a plurality of mounts 36 disposed in each tine plate 20. In the disclosed configuration, the mounts 36 are in the form of apertures; however, it should be understood that any suitable mount may be implemented. The interior plates can alternatively be fixed in place by any suitable means.

The tine assembly 12 further comprises at least a pair of top hitches 38 extending from the back plates 18 and in a direction opposite the direction of extension of the tine plates 20. The top hitch 38 is arranged and configured to receive portions of the wheel loader 100 for fixing the shear attachment assembly 10 thereto. The back plates 18 further comprise bottom hitches 40 (see FIGS. 3A and 3B) extending therefrom and being substantially parallel to the top hitches 38. The bottom hitches 40 are arranged and configured to receive a portion of the wheel loader 100 for fixing the shear attachment assembly 10 thereto.

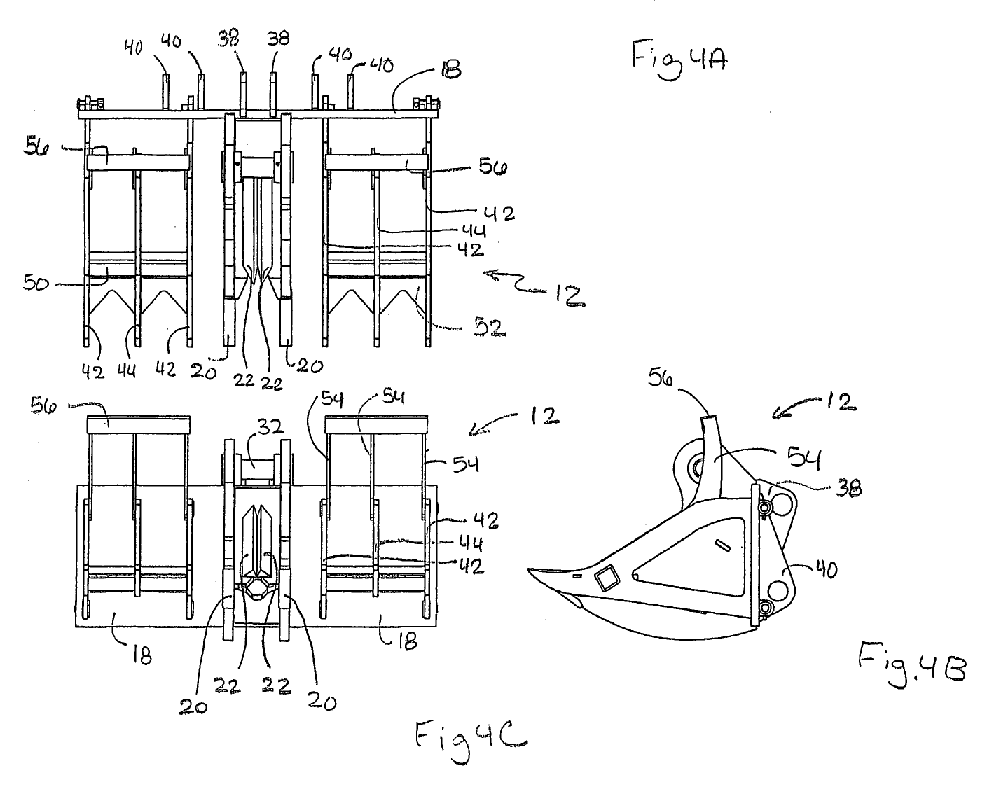

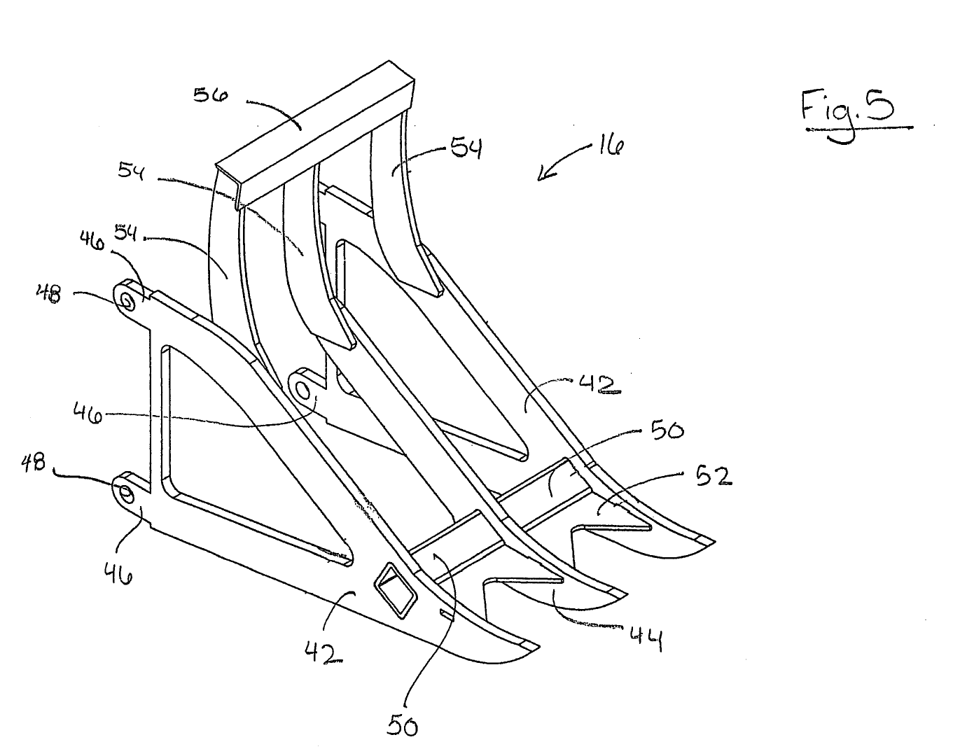

FIG. 4 illustrates the tine assembly 12 and a preferred manner of fixing the optional rake assemblies 16 thereto. Each rake assembly 16 is fixed to the tine assembly 12 at a back plate 18. Mount tabs 46 of the rake assembly 16 are aligned with and inserted through the plurality of rake mounts 24 disposed in the back plates 18. A mount pin 58 is disposed through a pin aperture 48 disposed in the mount tab 46 in order to fix the rake assembly 16 to the back plate 18. Although the mounting of only one optional rake assembly 16 is discussed, it is intended that each rake assembly 16 can be mounted to the tine assembly 12 in such a similar manner. FIGS. 4A-4C illustrate the tine assembly 12 having a pair of optional rake assemblies 16 fixed thereto.

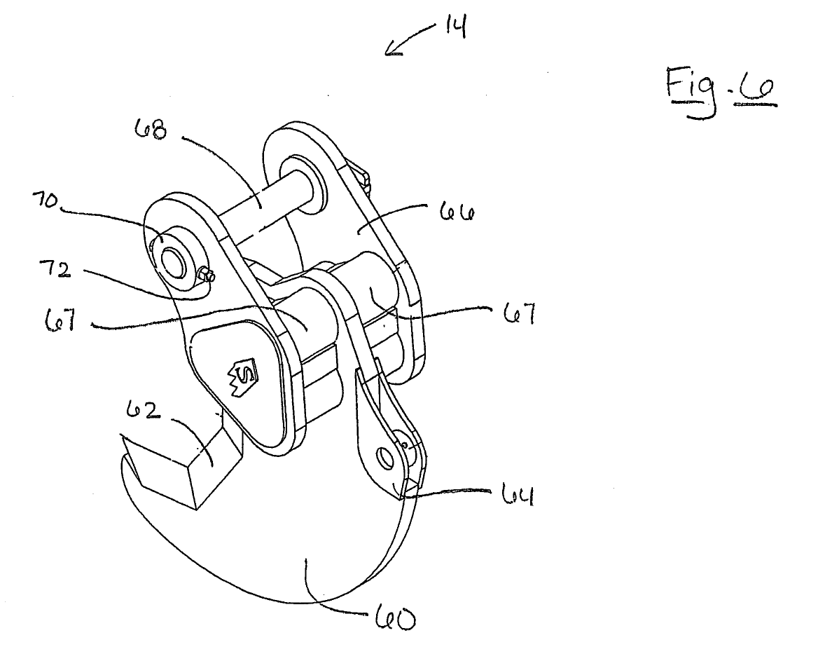

FIG. 5 more specifically illustrates an optional rake assembly 16 in greater detail. It should be understood that other rake assembly 16 configurations may be implemented. The rake assembly 16 comprises a pair of rake end tooth members 42 having a rake center tooth member 44 disposed therebetween. Each rake end tooth member 42 comprises a pair of mount tabs 46, each mount tab 46 having a pin aperture 48 disposed therebetween. The rake end tooth members 42 and rake center tooth member 44 are held together toward the bottom of the rake assembly 16 by a rake cross tube 50 extending therebetween. A rake tooth gusset 52 extends from the rake cross tube 50 toward the bottom end of the rake assembly 16. A brush guard extension plate 54 extends upward from each of the rake end tooth members 42 and the rake center tooth member 44. The brush guard extension plates 54 are held together as one unit by a top angle 56 disposed at the end thereof.

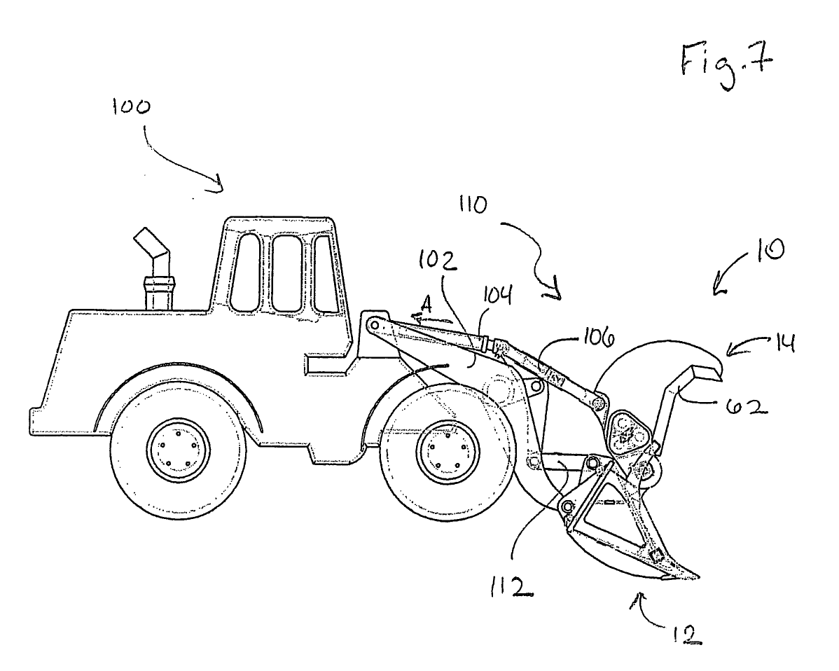

FIG. 6 illustrates a blade assembly 14 of the shear attachment assembly 10. The blade assembly 14 comprises a blade 60 having a cutting edge 62 disposed thereon. The blade 60 further comprises a stabilizer arm bracket 64 arranged and configured to receive the shear attachment stabilizer arm 106 for fixing the shear attachment assembly 10 to a loader 100. The blade 60 further comprises a pair of blade end covers 66. A main pin 68 and a pair of supports 67 span between the blade 60 and the blade end covers 66. The main pin 68 is preferably arranged and configured to be received through the pivot cross tube 32 of the tine assembly 12. In one configuration, as illustrated in FIG. 6, the main pin 68 is fixed to the blade end covers 66 with a pin lock block 70 having a pin lock 72 disposed therethrough. However, it should also be understood that the main pin 68 can be fixed between the blade end covers 66 in any suitable manner.

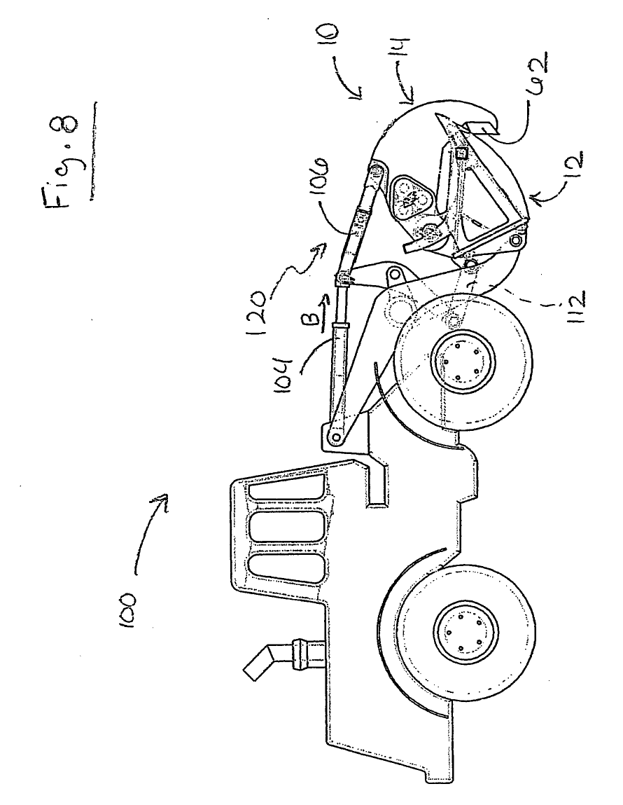

FIGS. 7 and 8 illustrate two operating positions of the shear attachment assembly 10 as fixed to a wheel loader 100. Turning first to FIG. 7, the shear attachment assembly 10 is illustrated in an open position 110. The open position 110 is characterized by the cutting edge 62 of the blade assembly 14 being disposed away from the tine assembly 12. The shear attachment assembly 10 can be used in the open position 110 for digging items out of the ground, such as a stump, for example, for grabbing items, or for any suitable purpose. The tine assembly 12 and the blade assembly 14 are disposed away from each other by pivoting about the connection of the pivot cross tube 32 of the tine assembly 12 and the main pin 68 of the blade assembly 14. The tine assembly 12 of the shear attachment assembly 10 is fixed to the wheel loader 100 at the loader arm 102 of the wheel loader 100 by the bottom hitch 40 of the tine assembly 12. The top hitch 38 of the tine assembly 12 is fixed to a Z-link 112 of the wheel loader 100.

The blade assembly 14 is fixed to the wheel loader 100 at a hydraulic arm 104 and shear attachment stabilizer arm 106, which is received at the stabilizer arm bracket 64 of the blade assembly 14. When the hydraulic cylinder 104 is moved in direction A, the shear attachment stabilizer arm 106 pulls the blade assembly 14 upward and away from the tine assembly 12. Substantially simultaneously, the Z-link 112 is extended, pushing the top portion of the tine assembly 12 away from the loader 100, resulting in the tine assembly 12 tilting downward and away from the blade assembly 14. In this configuration, the tine assembly 12 can be used to dig and scrape, or for any other suitable purpose.

FIG. 8 illustrates the shear attachment assembly 10 disposed in a closed position 120. The closed position 120 is characterized by the cutting edge 62 of the blade assembly 14 and the tine assembly 12 being disposed near each other such that the cutting edge 62 of the blade assembly 14 is disposed substantially adjacent to the tine chop blocks 22 of the tine assembly 12. The shear attachment assembly 10 can be used in the closed position 120 for holding items, cutting items, crushing items, or for any suitable purpose. The tine assembly 12 is disposed toward the closed position 120 when the hydraulic cylinder 104 is moved in direction B. The shear attachment stabilizer arm 106 pushes the blade assembly 14 downwardly at the stabilizer arm bracket 64. Simultaneously, the Z-link 112 is retracted, pulling the top hitch 38 of the tine assembly 12 toward the loader 100 and pivoting the tine assembly 12 upwardly.

It should be emphasized that the above described embodiments of the present invention, particularly any “preferred” embodiments, are merely possible examples of implementations, merely set forth for a clearer understanding of the principles of the invention. Many variations and modifications can be made to the above described embodiments of the invention without departing substantially from the spirit and principles of the invention. All such modifications and variations are intended to be included herein within the scope of this disclosure in the present invention and protected by the following claims.

1. A shear attachment assembly, comprising:
a blade assembly; and
a tine assembly being arranged and configured to releasably receive a rake assembly thereon.

2. The shear attachment assembly of claim 1, wherein:
said blade assembly comprises a main pin; and
said tine assembly comprising a pivot cross tube arranged and configured to receive said main pin of said blade assembly axially therethrough to pivotally fix said blade assembly to said tine assembly.

3. The shear attachment assembly of claim 1, wherein said blade assembly further comprises:
a blade having a cutting edge disposed thereon.

4. The shear attachment assembly of claim 1, wherein said blade assembly further comprises:
a stabilizer arm bracket arranged and configured to fix said blade assembly to motorized equipment for use of said shear attachment assembly.

5. The shear attachment assembly of claim 1, wherein said tine assembly further comprises:
a tine plate; and
a frame extending from said tine plate;
wherein said back plate is arranged substantially perpendicular to said tine plate.

6. The shear attachment assembly of claim 5, wherein said frame extending from said tine plate comprises a back plate.

7. The shear attachment assembly of claim 5, wherein said tine assembly further comprises a tine chop block disposed beside said tine plate.

8. The shear attachment assembly of claim 5, wherein said tine plate further comprises a mount for fixing a tine chop block to said tine plate.

9. The shear attachment assembly of claim 5, wherein said frame further comprises a rake mount for fixing a rake assembly to said back plate.

10. The shear attachment assembly of claim 1, wherein said tine assembly further comprises:
a top hitch for fixing said tine assembly to motorized equipment for use of said shear attachment assembly; and
a bottom hitch for fixing said tine assembly to motorized equipment for use of said shear attachment assembly.

11. The shear attachment assembly of claim 9, wherein said motorized equipment comprises a wheel loader.

12. The shear attachment assembly of claim 1, wherein said tine assembly further comprises:
a back plate; and
a rake assembly releasably fixed to said back plate.

13. The shear attachment assembly of claim 11, wherein said rake assembly comprises:
a pair of rake end tooth members; and
a rake center tooth disposed between said pair of rake end tooth members.

14. The shear attachment assembly of claim 12, wherein said rake assembly further comprises:
a rake cross tube fixing said rake center tooth to said pair of rake end tooth members.

15. The shear attachment assembly of claim 12, wherein said rake assembly further comprises:
a brush guard extension plate extending upward from said pair of end tooth members and said rake center tooth.

16. A shear attachment assembly, comprising:
a blade assembly having a blade with a cutting edge disposed thereon; and
a tine assembly having a back plate and a tine chop block extending from said back plate;
wherein said back plate is arranged and configured to releasably receive a rake assembly thereto.

17. A shear attachment assembly of claim 15, wherein said blade assembly and said tine assembly are pivotally fixed together such that said cutting edge of said blade assembly and said tine chop block of said tine assembly can work together in a shear cutting motion.

18. The shear attachment assembly of claim 15, wherein said rake assembly comprises:
a pair of rake end tooth members; and
a rake center tooth disposed between said pair of rake end tooth members.

19. The shear attachment assembly of claim 17, wherein said rake assembly further comprises:
a rake cross tube fixing said rake center tooth to said pair of rake end tooth members.

20. The shear attachment assembly of claim 17, wherein said rake assembly further comprises:
a brush guard extension pate extending upward from said pair of end tooth members and said rake center tooth.

21. The shear attachment assembly of claim 15, further comprising:
a stabilizer arm bracket disposed on said blade assembly and being arranged and configured to fix said blade assembly to motorized equipment for use of said shear attachment assembly;
a top hitch disposed on said tine assembly and being arranged and configured to fix said tine assembly to motorized equipment for use of said shear attachment assembly; and
a bottom hitch disposed on said tine assembly and being arranged and configured to fix said tine assembly to motorized equipment for use of said shear attachment assembly.

22. The shear attachment assembly of claim 20, wherein said motorized equipment comprises a loader.

23. A shear attachment assembly comprising:
a blade assembly comprising:
a blade having a cutting edge disposed thereon;
a main pin; and
a stabilizer arm bracket arranged and configured to fix said blade assembly to motorized equipment for use of said shear attachment assembly;
a tine assembly comprising:
a pair of tine plates;
a pair tine chop blocks each having a cutting edge and being disposed between each of said pair of tine plates;
a pair of back plates extending outward from said pair of tine plates, wherein each of said pair of back plates is arranged and configured to releasably receive a rake assembly; and
a pivot cross tube being arranged and configured to receive said main pin of said blade assembly axially therethrough such that said cutting edge of said blade assembly aligns between said pair of tine chop blocks;
a top hitch for fixing said tine assembly to motorized equipment for use of said shear attachment assembly; and
a bottom hitch for fixing said tine assembly to motorized equipment for use of said shear attachment assembly;
a pair of rake assemblies each rake assembly of said pair being arranged and configured to be removably fixed to one back plate of said pair of back plates;
said rake assembly comprising:
a pair of rake end tooth members;
a rake center tooth disposed between said pair of rake end tooth members;
a rake cross tube fixing said rake center tooth to said pair of rake end tooth members; and
a brush guard extension plate extending upward from said pair of end tooth members and said rake center tooth.

24. The shear attachment assembly of claim 22, wherein said motorized equipment comprises a loader.
